(19) United States
(12) Patent Application Publication
(10) Pub. No.: US 2003/0204313 A1
(43) Pub. Date: Oct. 30, 2003

(54) Biosensing meter

(76) Inventors: Yao Ou-Yang, Junghe City (TW); Xing Ou-Yang, Junghe City (TW); Ja-Shi Wu, Taipei (TW); Shu-Mei Wu, Taipei (TW); Chao-Wang Chen, Taipei (TW)

Correspondence Address: RABIN & CHAMPAGNE, P.C., Suite 500, 1101 14th Street, N.W., Washington, DC, 20005, US

(21) Appl. No.: 10/132,302

(22) Filed: Apr. 26, 2002

(51) Int. Cl. G06F 19/00

(52) U.S. Cl. 702/19

(57) ABSTRACT

A biosensing meter, applicable to measure glucose, uric acid or cholesterol level in the human body, such that a user can inspect the body condition of himself/herself at any time. The biosensing meter has a slot to be plugged with a key code strip, a correction strip or an inspection strip under various conditions, so as to activate input procedure and operation parameters. Therefore, an equipment calibration can be performed as required. When an analyte-containing fluid (normally blood) is dripped on the inspection strip, the inspection result is obtained according to the operation procedure and parameters obtained previously,

### SCENARIO OF THE INVENTION

1. Field of the Invention

The present invention relates in general to a biosensing meter. More particularly, the present invention relates to an electrochemical glucose biosesnsor.

2. Description of the Related Art

The biosensing meter applied for detecting the substance contained in the blood to be analyzed, such as glucose or cholesterol normally employs a disposable sample strip to complete the inspection. The sample strip has a reaction well to allow blood dripped thereon. Via the combination of microprocessor/ROM, the whole operation is controlled. Further by execution various procedures, the analysis results for measurement are obtained. However, the advancement of technique continuously alters the operation procedure of measurement. To the bio-inspection field, the measurement factor is changed according to the manufacture of sample strip. However, if the hardware in the sensing meter cannot be upgraded consequently, the purchased sensing meter is then inapplicable for the new batch of sample strips. As a result, the sensing meter has to be renewed. Such method is very impractical.

Another conventional sensing meter improves the above drawbacks by adding another slot on the sensing meter. According to the position for plugging the sample strip, an additional memory key is designed and inserted therein. While performing measurement, the memory key has to be inserted in the sensing meter all the time for the same batch of sample strips. According to the operation procedure and parameter provided by the memory key, a correct measurement result is obtained.

### SUMMARY OF THE INVENTION

The present invention provides a biosensing meter which has the upgrading function. Different from the prior art, the biosensing meter provided by the present invention has only one slot to be plugged with one of the key code strip, the correction strip, or the inspection strip under specific condition. The input operation procedure and operation parameter are thus activated. As required, the equipment calibration can be performed. A reactant to be analyzed (normally blood) is dripped on the inspection strip, and the inspection result can be obtained according to the previously obtained operation procedure and parameter.

Accordingly, the biosensing meter provided by the present invention comprises only one slot which can accept one of the key code strip and an inspection strip. The inspection strip comprises a reaction well and a plurality of electrodes thereon. A reactant is contained in the reaction well, while the electrodes are in contact with the reaction well. The biosensing meter further comprises a voltage source, a sensing amplifier, a writable memory and a microprocessor. The voltage source provides an operation voltage to the inspection strip electrode. The sensing amplifier is coupled to another inspection strip electrode. When an analyte-containing fluid is dripped on the reaction well, an output signal is generated to correspond to a sensing current. The key code strip is plugged in the slot in advance. A plurality of parameters and operation procedure controlling operation of the biosensing meter stored in an EEPROM circuit is read by the writable memory of the biosensing meter in responding to the operation procedure and parameters obtained from the key code strip, the microprocessor determines a plurality of voltages with a predetermined lasting time provided by the voltage source, while the voltages and lasting time are obtained from the data stored in the EEPROM of the key code strip. The microprocessor controls the sensing amplifier to provide a plurality of signal outputs through a predetermined time, so as to display an analysis result obtained by measuring the analyte-containing fluid. Similarly, the specific parameter controlled by the sensing amplifier is also obtained from the data stored in the EEPROM of the key code strip.

A correction strip can also be plugged into the slot. The correction strip comprises a resistor circuit for calibrating the biosensing meter. Alternatively, the key code strip may comprises a resistor circuit for having the function to calibrate the biosensing meter.

Both the foregoing general description and the following detailed description are exemplary and explanatory only and are not restrictive of the invention, as claimed.

### BRIEF DESCRIPTION OF THE DRAWINGS

FIG. 1 shows a conventional biosensing meter;

FIG. 2 shows the circuit structure of a memory key used in the conventional biosensing meter as shown in FIG. 1;

FIG. 3 shows a schematic drawing of a biosensing meter according to the present invention;

FIGS. 4A to 4D shows the schematic drawings of sample strips for various functions applied to the biosensing meter according to the present invention; and

FIGS. 5A to 5D shows the system structure of the present biosensing meter for various sample strips as shown in FIGS. 4A to 4D.

### DESCRIPTION OF THE PREFERRED EMBODIMENTS

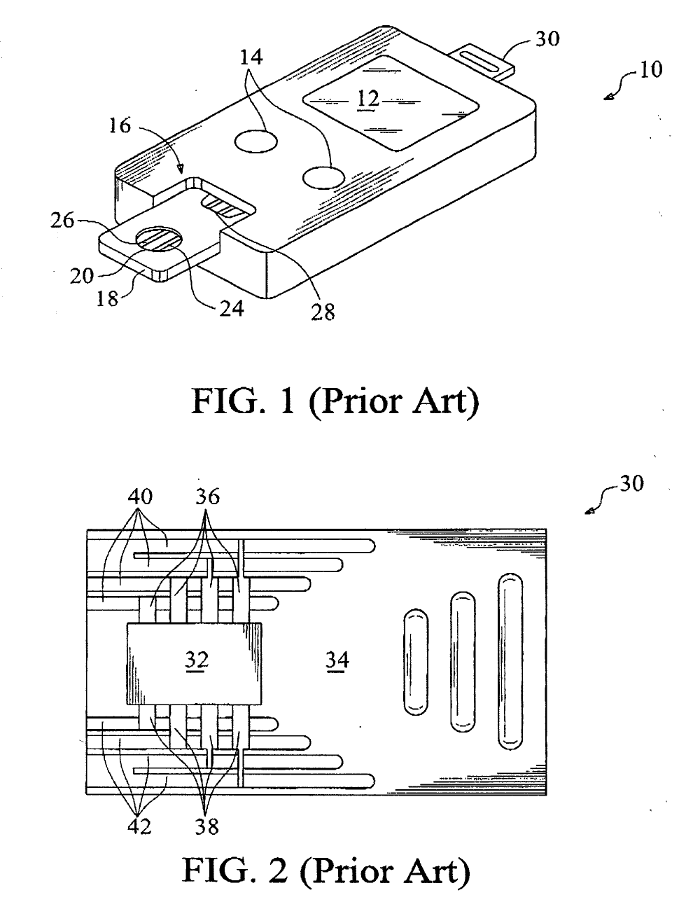

Referring to FIG. 1, a conventional biosensing meter 10 has a display 12, a control key 14 and a slot 16 able to receive a disposable sample strip 18. The sample strip 18 has a reaction well 20 which contains a pair of conductive electrodes 24 and 26. An enzymatic reactant layer (not shown) is formed in the reaction well 20 to cover the electrodes 24 and 26. An analyte-containing fluid, for example, a drop of blood, is dripped on a substrate layer. The end of the disposable sample strip has an opening 28 allowing the electrodes 24 and 26 to be exposed, such that the sample strip 18 is electrically connected to the biosensing meter 10. The conventional biosensing meter 10 further has a plug-in ROM key 30, which is inserted into another slot of the biosensing meter 10 to be electrically connected thereto and to establish a mutual communication therebetween.

The structure of the ROM key 30 is shown in FIG. 2, which comprises a programmable ROM chip 32 disposed on a substrate surface 34. A plurality of conductive wires 36 and 38 are connected to individual recesses 40 and 42 via the ROM chip 32. The substrate 34 provides support of the chip 32, while the recesses 40 and 42 ensures that the contact between the biosensing meter 10 and the conductive wires 36 and 38 are not short circuited after the ROM key 30 is inserted into the biosensing meter 10.

After inserting the ROM key 30 into the biosensing meter 10, a plurality of elastic conductive splints inside of the biosensing meter 10 are in contact with the conductive wires 36 and 38, such that the data stored in the ROM chip 32 can be read by the microprocessor in the biosensing meter 10. That is, when the biosensing meter 10 is performing the measurement, the ROM key 30 has to be inserted in the biosensing meter 10 all the time. The function of the ROM key 30 has to match different batch of sample strips to provide information of operation procedure and parameters for each * batch of sample strips, so that the biosensing meter 10 is upgraded.

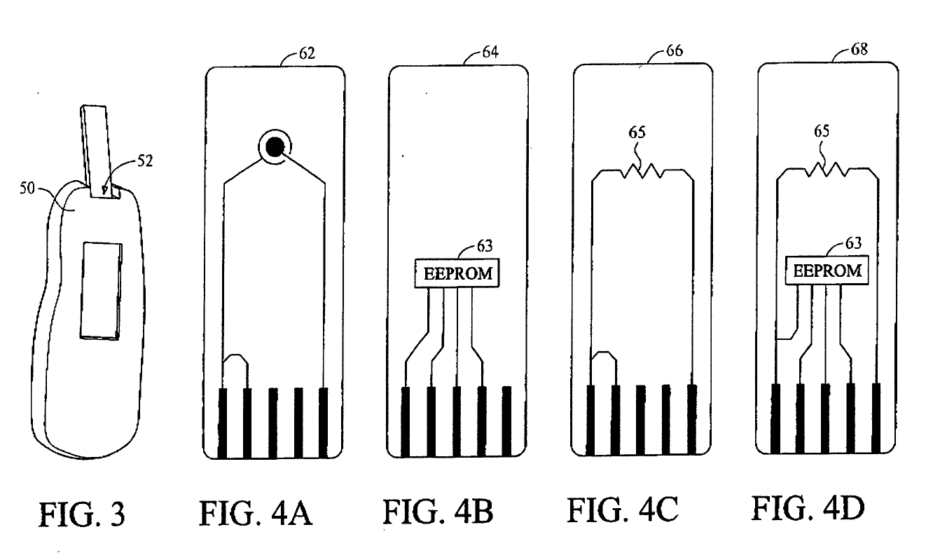

Referring to FIG. 3, a schematic drawing of a biosensing meter 50 provided by the present invention is shown. From the appearance, the significant difference includes the only one slot 52, while the biosensor with the upgrade effect for different batch of sample strips is provided.

As shown in FIGS. 4A to 4D, each of the sample strips such as a inspection strip 62, a key code strip 64, a correction strip 66 and multi-function strip 68 has specific function and is to be inserted into the slot 52. The inspection strip 62 is for inspection and has the structure similar to that of the sample strip 18, that is, it comprises the reaction well and electrodes. The key code strip 64 is equivalent to the a above ROM key 30, above which with an EEPROM chip 63 is disposed. The * correction strip 66 provides the correction and includes circuit with a resistor 65, which is to provide the correction function of the biosensing meter 50 of the present invention. When the biosensing meter 50 is performing measurement, and the measurement result has inaccuracy, such correction strip 66 can be inserted to retrieve the original sensing parameter. The sample strip 68 has dual functions, that is, the sample strip 68 incorporates the functions of the key code strips 64 and correction strip 66 therein, such that while providing operation parameter and program, the sensing meter 50 can be calibrated simultaneously.

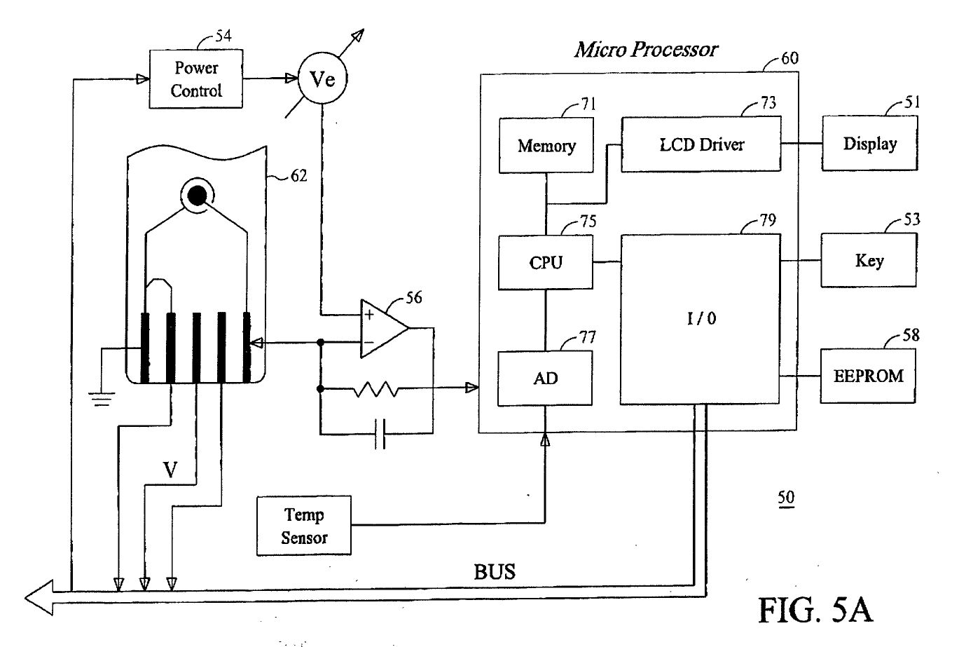

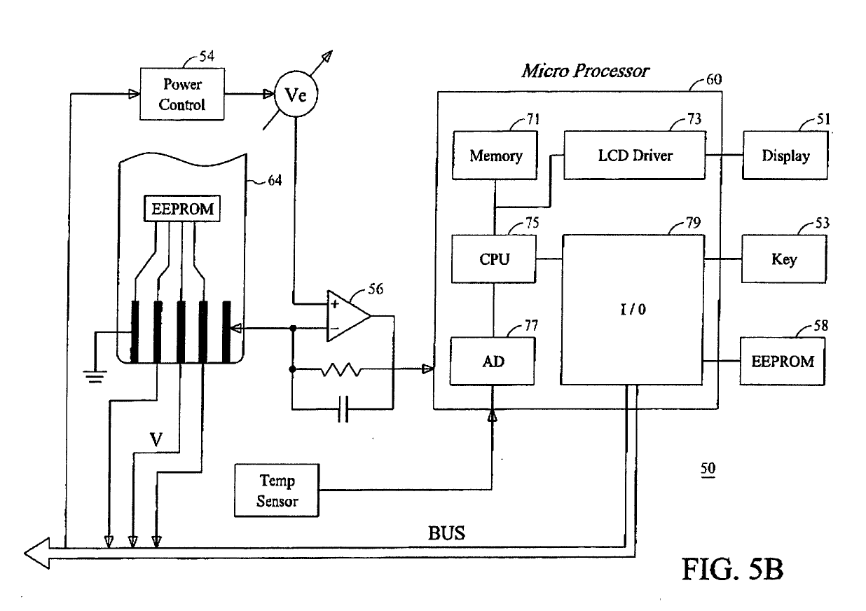

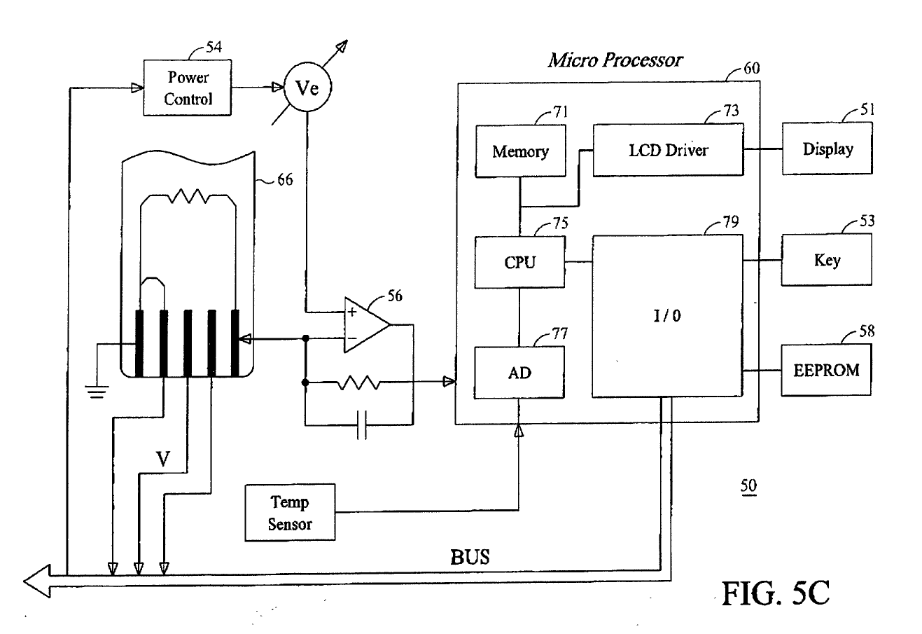

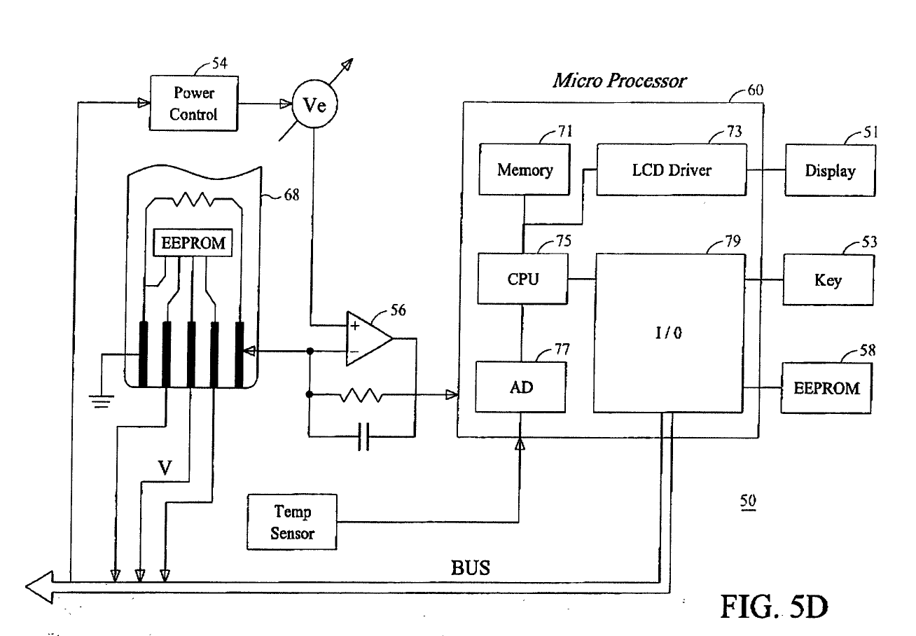

The system structure of the biosensing apparatus 50 of the present invention is illustrated as FIGS. 5A to 5D, which shows the conditions for inserting various sample strips 62, 64, 66 and 68. The biosensing meter 50 provided by the present invention includes a display 51, a key 53, a power control 54, a sensing amplifier 56, an EEPROM 58 and an integrated microprocessor 60. The microprocessor 60 further comprises a memory 71, a LCD driver 73, a CPU 75, an A/I) converter 77 and an I/O apparatus 79. A power controller 54 provides an operation voltage to an inspection strip electrode, and the sensing amplifier 56 is connected to another inspection strip electrode. When an analyte-containing fluid, for example, a drop of blood, has been dripped in the reaction well of the inspection strip 62, an output signal corresponding to a sensing current is generated. The key code strip 64 is plugged into the slot 52 in advance, such that a plurality of parameters and an operation procedure controlling operation of the biosensing meter stored in the EEPROM chip 63 are read. With responding to the operation procedure and parameters obtained from the key code strip 64, the microprocessor 60 determines a plurality of voltages with a predetermined lasting time provided by the power control 54. The voltages and the lasting time are obtained from the data stored in the EEPROM chip 63 of the key code strip 64. The microprocessor 60 controls the sensing amplifier 56 to provide a plurality of signal outputs after a predetermined time, so as to display an analysis result measured from the analyte-containing fluid. The controlled specific parameter of the sensing amplifier is also obtained from the data stored in the EEPROM chip 63 of the key code strip 64.

In the system structure as shown in FIGS. 5C and 5D, the resistor 65 circuit on the correction strip 66 can achieve the objective of calibrating the sensing meter 50. The sample strip 68 combining the functions of the key code and correction strips can be used for correction of input parameter and the operation procedure in the same manner at the same time.

It is easy to understand that the above-mentioned biosensing meter 50 can achieve the advantages of reducing components required therein so as to save the cost.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A biosensing meter, having a slot able to accept a key code strip and an inspection strip, which further comprises a reaction well and a plurality of electrodes thereon in contact with the reaction well, the biosensing meter farther comprising a voltage source; a sensing amplifier; a writable memory; and a microprocessor; wherein the voltage source provides an operation voltage to an inspection strip electrode, and the sensing amplifier is connected to another inspection strip electrode, and when an analyte-containing fluid is dripped in the reaction well, an output signal corresponding to an sensing current is generated; wherein the key code strip is plugged in the slot in advance to allow the writable memory of the biosensing meter reading a plurality of parameters and an operation procedure controlling operation of the biosensing meter stored in an EEPROM of the key code strip, the microprocessor then responds the operation procedure and parameters to determine a plurality of voltages with a predetermined lasting time, where the voltages and the lasting are also obtained from the data stored in the EEPROM of the key code strip; and wherein the microprocessor controls the sensing amplifier providing a plurality of signal outputs with a predetermined time to display an analysis result measured from the analyte-containing fluid, while a specific parameter controlled by the sensing amplifier is also obtained from the data stored in the EEPROM of the key code strip.

2. The biosensing meter according to claim 1, further comprising a correction strip that can be plugged into the slot, and the correction strip comprises a resistor circuit to calibrate the biosensing meter.

3. The biosensing meter according to claim 1, wherein the key code strip further comprises a resistor circuit to calibrate the biosensing meter.
